(19) United States
(12) Patent Application Publication
(10) Pub. No.: US 2026/0105116 A1
(43) Pub. Date: Apr. 16, 2026

(54) WEBSITE CONTENT GENERATION USING MACHINE LEARNING

(71) Applicant: Webflow, Inc., San Francisco, CA (US)

(72) Inventors: Andrew Del Prete, Woodland Park, CO (US); Roger Yang, Lawrenceville, CA (US); Nathan Thomas, Madrid (ES); Amanda Cox, Seattle, WA (US); Jason Okra, Seattle, WA (US); Sheryl Sulistiawan, Brooklyn, NY (US)

(21) Appl. No.: 19/356,917

(22) Filed: Oct. 13, 2025

Related U.S. Application Data
(60) Provisional application No. 63/707,167, filed on Oct. 14, 2024.
(60) Provisional application No. 63/707,158, filed on Oct. 14, 2024.

(51) Int. Cl. G06F 16/958; G06F 3/04842; G06F 16/3329; G06F 40/166

(52) U.S. Cl. CPC G06F 16/958; G06F 3/04842; G06F 16/33295; G06F 40/166

(57) ABSTRACT

Methods, systems, and apparatus, including computer programs encoded on computer storage media, for digital content creation within website environments. In some implementations, a server receives request data from a client device, which specifies an action corresponding to a text segment displayed on the client device. The server identifies a content item that (i) corresponds to the text segment, and (ii) is structured according to a collection schema. The server generates prompt data for trained machine learning (ML) models, the prompt data includes a text generation instruction based on the content item. The server provides the prompt data to the trained ML models and obtains a candidate output in response. The server determines that the candidate output is valid. In response, the server generates graphical user interface (GUI) data for the client device to display the candidate output. The server transmits the GUI data to the client device.

### CROSS-REFERENCE TO RELATED APPLICATIONS

This application claims the benefit of U.S. Provisional Application Nos. 63/707,158 and 63/707,167, each filed on Oct. 14, 2024, the contents of which are incorporated by reference in their entirety.

### TECHNICAL FIELD

This disclosure generally describes technology relating to machine learning, and more particularly, to technology related to the integration of machine learning to cloud-based software platforms.

### BACKGROUND

Machine learning (ML) enables systems to learn from data and improve their performance without being explicitly programmed for every task. Rather following predefined rules, ML systems build models based on patterns found in large datasets. These models may then make predictions, classify data, or perform decision-making tasks based on new, unseen data. ML may involve providing input data into a trained model, which processes the providing data to identify patterns or relationships within the data.

Machine learning may involve several types of learning. For example, in supervised learning, a model is trained on labeled data, where both the inputs and desired outputs are known. The goal is to learn a mapping from inputs to outputs to make predictions on new, unlabeled data. As another example, in unsupervised learning, a model works with data that has no labeled outcomes. Another example is reinforcement learning, where a model learns by interacting with an environment and receiving feedback in the form of rewards or penalties. ML has applications across industries, including healthcare, finance, and consumer-focused technologies. In the context of healthcare, ML systems and techniques may be useful to predict diseases, analyze medical images, and provide other advantages.

Often, web design teams rely on external machine learning tools to assist in generating website content. This typically requires the teams to provide requests to the external machine learning tools, and paste results output by the machine learning tools into their website creation environment. However, this copy and paste often produces mismatches in structure and content, especially in a website creation environment that includes platform specific structures and schema rules that must be adhered to. Transferring data between external machine learning output and the website creation environment also disrupts the flow of website creation and adds latency to the website creation process.

### SUMMARY

This specification relates to systems and techniques that leverage ML to improve various aspects of digital content generation within website environments. Content generated through use of ML models may be constrained to a collection schema specified by a content management system (CMS). This approach ensures that automatically-generated content (e.g., website content generated by an ML model) is grounded in the data structure and the subject matter defined by the CMS. By incorporating schema constraints (e.g., required fields, data types, and character limits) directly into the content generation process, the systems and techniques disclosed herein ensure resulting outputs are structurally compatible with backend infrastructure. Furthermore, by leveraging existing content and the specific action requested by a user, the systems ensure that generated text is also thematically consistent and relevant to the immediate context, thereby producing ML-generated content that is validated for both structural integrity and contextual accuracy.

For example, a system may receive a request from a client device for performing an action related to text displayed on a webpage. Such actions include rewriting a portion of the text on the webpage, expanding the portion of the text, or shrinking a portion of the text, to name a few examples. The system may then identify content type and structure for that request from a database. The structure for that content corresponds to a schema, which defines the fields, data types for the content, the data values, constraints, and in some cases, a collection which references this schema. A collection refers to a group of a set of items for a particular product and each of the items share the same fields.

The system may generate a prompt that includes various content for performing the requested action on the displayed text. In some implementations, the generated prompt is built to conform to the schema identified from the database and includes relevant content. The relevant content may include, for example, additional context surrounding the displayed text on the webpage or webpage metadata, in order to enhance the machine learning model's understanding and production of output. In response, the system may provide the generated prompt as input to the machine learning model. The machine learning model returns a set of candidate outputs based on the generated prompt, which are validated against the retrieved schema and cleansed to ensure uniformity with the displayed text on the webpage. The system may discard any candidate outputs that do not validate to the retrieved schema.

Upon successful validation with the retrieved schema, the system may provide graphical user interface (GUI) data to the client device using the set of candidate outputs as a response to the user's request. The client device may present each candidate output of the set of candidate outputs as an alternative response to the request for a result of performing the action on the displayed text. If the user accepts one of the alternative options, the client device updates the displayed text inline on the webpage accordingly. If the user declines the set of candidate outputs, then the user may issue another request to the system.

In some implementations, the system may organize website content into collections. A collection is a group whose items share the same set of fields. The fields may include, for example, a title, summary, body, date, other fields, or reference another collection. The server may employ content management systems that allow users to create, publish, and modify digital content in collections without coding experience. For example, when a webpage designer seeks to generate a webpage, the designer may bind one or more collections to their webpage and bind the fields of the one or more collections to their webpage so a single design may be used to drive the creation of multiple webpage, if the designer prefers. The system may ensure that material submitted to and received from the machine learning model conforms to the schema defined for the one or more collections of the webpage. This may include, for example, ensuring the material fits rules, parameters, design constraints, and other formatting before the material is displayed on the client device.

In some implementations, a user may enter a text prompt that enables different creation of website content for a collection. For example, the user may request execution of a single item generation, where the machine learning model is prompted to create a new single item for a respective collection and populate the fields of the respective collection using validated and cleansed output. In another example, the user may request execution of rich text actions for text displayed on a webpage. The rich text actions may include a request to rewrite a text segment, change tone, translate, fix spelling and grammar, expand text, reduce text, or elaborate on missing portions of text. The system may populate the portion of text with the output from the machine learning model according to the rich text action. In another example, the user may request creation of a collection and specify one or more items for that collection.

In some implementations, these ML techniques operate within a broader Web Experience Platform (WEP) technique in order to improve various aspects of web development, such as automatic page generation, component refactoring, localization, and performance tuning within a comprehensive website development platform, such as the WEP. In the WEP, machine learning models, e.g., large language models (LLMs), large action models (LAMs), may be trained and/or prompted using extensive datasets including versioned design snapshots, CMS collection content, component code libraries, build artifacts, and historical performance metrics. This data is leveraged during live authoring and runtime management sessions to generate new layout structures, translate content into additional languages, rewrite copy to meet accessibility guidelines, recommend edge caching strategies, and adjust build configurations for faster load times. By using these insights, the ML models enhance the experience of site controllers who design and maintain websites and of site users who access published pages. The integration of such ML models within the WEP also streamline backend operations by triggering incremental builds, updating database records, applying schema validations, and scheduling targeted cache invalidations without manual intervention. In this way, the incorporation of ML models improves not only the user experience delivered by the WEP, but also optimizes the underlying technical infrastructure that stores data, compiles builds, and serves content across the WEP.

The systems and techniques disclosed herein leverage ML to improve website development with varying levels of process automation. For example, a site controller may type a natural language request asking for a five-page marketing microsite, and an ML model may generate the corresponding page structures, themed style tokens, component markup, and placeholder media. The build pipeline then compiles these assets, writes them to the artifact repository, and publishes them through the edge delivery layer without the controller writing any code. As another example, when a site controller requests a redesigned testimonial slider, a ML model may query a content database to understand existing collection fields and reference links and then generates an updated component that preserves field binding relationships. The build system validates the generated markup against the CMS schema, updates only the affected bundle, and deploys the component so the new slider renders correctly across all locales without breaking any data driven pages.

In various implementations, the systems may use machine learning models to refine or extend existing websites after initial deployment. For example, a controller may prompt an assistant to translate all product collection items into Spanish and adjust the layout for right-to-left reading flows. The inference connector enriches the prompt with collection records from the content database, the language model returns translated strings and updated style rules, and the build system regenerates only the affected locale bundles, so the localized version appears online with minimal delay.

In one general aspect, a method is performed by a server. The method includes: receiving, by a server system, request data from a client device, where the request data specifies an action corresponding to a text segment displayed on the client device; identifying, by the server system and based on the request data, a content item that corresponds to the text segment, and is structured according to a collection schema of a content management system; generating, by the server system, prompt data for one or more trained machine learning (ML) models, where the prompt data includes a text generation instruction based on the content item; providing, by the server system, the prompt data to the one or more trained ML models; obtaining, by the server system, a candidate output from the one or more trained ML models in response to providing the prompt data; determining, by the server system, that the candidate output is valid based on the collection schema and the text generation instruction; in response to determining that the candidate output is valid, generating, by the server system, graphical user interface (GUI) data for the client device to display the candidate output, where the GUI data, when received by the client device, causes the client device to adjust a display of the text segment based on the candidate output; and transmitting, by the server system, the GUI data to the client device.

Other implementations of this and other aspects of the disclosure include corresponding systems, apparatus, and computer programs, configured to perform the actions of the methods, encoded on computer storage devices. A system of one or more computers may be so configured by virtue of software, firmware, hardware, or a combination of them installed on the system that in operation cause the system to perform the actions. One or more computer programs may be so configured by virtue having instructions that, when executed by data processing apparatus, cause the apparatus to perform the actions.

The foregoing and other implementations may each optionally include one or more of the following features, alone or in combination. For example, some implementations include all the following features in combination.

In some implementations, the text generation instruction includes a machine-readable representation of rules derived from the collection schema.

In some implementations, receiving the request to perform the action with respect to the text segment displayed on the client device includes: receiving, by the server system, the request to perform at least one of a rewrite, a change in tone, a translation, a correction of spelling and grammar, or a change in length, of the text segment, where the action is selected by a user interacting with the text segment on the client device.

In some implementations, identifying the content item includes: extracting, by the server system, an identifier from the request data; and locating, by the server system, the content item within the content management system using the identifier.

In some implementations, the collection schema specifies a plurality of data types, permitted fields, field data types, and disallowed fields for the content item.

In some implementations, generating prompt data for one or more trained ML models includes: extracting, by the server system, data from the request, the data including the text segment, a second text segment surrounding the text segment, and a collection applied on a webpage including the text segment; generating, by the server system, a machine-readable data encoding the permitted fields, the field data types, formats, and the disallowed fields specified by the collection schema; and embedding, by the server system, the machine-readable data within the prompt data.

In some implementations, the prompt data is provided to the one or more trained ML models over a network.

In some implementations, the candidate output includes a JavaScript Object Notation (JSON) object that includes values for a set of permitted fields specified by the collection schema.

In some implementations, the method includes: obtaining, by the server system, a second candidate output from the one or more trained ML models; determining, by the server system, that the second candidate output does not conform to one or more constraints specified in the collection schema; in response to determining that the second candidate output does not conform to the one or more constraints specified in the collection schema, generating, by the server system, an error report identifying one or more fields from the second candidate output that does not successfully conform to the one or more constraints specified in the collection schema; and transmitting, by the server system, the error report to the client device.

In some implementations, the method includes: identifying, by the server system and based on the request data, a second content item that is specified in the content management system as being associated with the content item; generating, by the server system, second prompt data for the one or more trained ML models, where the second prompt data includes a second text generation instruction based on the second content item; providing, by the server system, the second prompt data to the one or more trained ML models; and obtaining, by the server system, a second candidate output from the one or more trained ML models in response to providing the second prompt data.

In some implementations, the GUI data includes the second text segment, metadata identifying a target collection associated with the content item, and a second content item associated with the second text segment.

In some implementations, the method includes: obtaining, by the server system, a plurality of candidate outputs from the one or more trained ML models; and generating, by the server system, second GUI data based on the plurality of candidate outputs, where the second GUI data includes a candidate controller configured to enable a user to cycle through each candidate output of the plurality of candidate outputs for display on the client device, and a candidate selector that enables the user to select one of the plurality of candidate outputs to replace the text segment.

In some implementations, generating the second GUI data includes generating, by the server system, a difference view that includes one or more edits between the text segment and each candidate output included in the plurality of candidate outputs.

In some implementations, the method includes: determining, by the server system, that a first subset among the plurality of candidate outputs is valid; determining, by the server system, that a second subset among the plurality of candidate outputs is not valid, where candidate outputs included in the second subset are not included in the first subset; and discarding, by the server system, candidate outputs included in the second subset, and where the GUI data further includes an indicator identifying candidate outputs included in the second subset that have been discarded by the server system.

In some implementations, the method includes: the GUI data specifies a regenerate control setting; and the method further includes: receiving, by the server system, user input data indicating activation of the regenerate control setting after the GUI data has been transmitted to the client device, and in response receiving the user input data: generating, by the server system, second prompt data for the one or more trained ML models, where the second prompt data includes a second text generation instruction based on the user input data indicating activation of the regenerate control; providing, by the server system, the second prompt data to the one or more trained ML models; and obtaining, by the server system, a second candidate output from the one or more trained ML models in response to providing the second prompt data.

The details of one or more implementations of the disclosure are set forth in the accompanying drawings and the description below. Other features, objects, and advantages of the invention will be apparent from the description and drawings, and from the claims.

### BRIEF DESCRIPTION OF DRAWINGS

FIG. 1 illustrates an example of a technique for generating website content using machine learning.

FIG. 2 illustrates an example of a web experience platform (WEP) for enabling web development using one or more ML models.

FIGS. 3A-3B illustrate example user interfaces for generating website content using machine learning.

FIG. 4 illustrates an example user interface for cycling through different output alternatives from the machine learning model for generating website content.

FIG. 5 illustrates an example user interface for performing a rich text action on a webpage for generating website content.

FIG. 6 is a flow chart illustrating an example of a method for creating website content according to a user request using ML.

In the drawings, like reference numbers represent corresponding parts throughout.

### DETAILED DESCRIPTION

This disclosure describes the application of ML techniques to improve various aspects of web development, such as creating and modifying website content directly within a website environment. In some implementations, the systems described herein enable users to create new content management for a webpage using a CMS that involves ML. Generally, the CMS is a software application that allows users to create, publish, and modify digital content without coding experience. Users may interact with the CMS to manage websites and website content regardless or technical expertise or skill level. This is at least in part due to the CMS providing a GUI on a client device with tools for creating, editing, and publishing content online.

In some implementations, the system may generate website content using the ML model in response to a request provided by a user. For example, a user may interact with a text segment displayed on a webpage of a website through a client device. The user may desire to modify a portion of the webpage, change content displayed on the webpage, update formatting of one or more sections of the webpage, or change schemes shown on the webpage, to name a few examples. Continuing with the above example, the user may request through the client device a rewrite of the text segment or a portion of the text segment, an expansion of the text, a reduction of the text, a translation of the text, or an adjustment of the tone of the text currently displayed on the webpage. The client device may provide the selected text, text surrounding the selected text, a page identifier, and other data to the server to generate responses to the text. Accordingly, the system may generate and replace the text segment within the website environment, without the user having to access any output provided by the machine learning model, and preserving the user's creative flow process.

Some approaches to website creation typically require authors to switch screens, switch application, or switch between tools to generate webpage content. In this case, an author may initiate the creation of a webpage. If the author desires to use a machine learning tool as part of the webpage creation, the author switches to the machine learning tool and invokes the machine learning tool to create an output for the webpage creation. In this case, the author copies the output from the machine learning tool and pastes the output into the website environment on the client device. However, this copy-and-paste transition creates many technical challenges. For one, the formatting output by the machine learning tool often conflicts with the formatting required by the author's website. This requires the author to manually change the formatting to a target formatting and interrupts the author's flow of website creation. In some examples, the output of the machine learning model may lack the desired field structure, length limits, or data type constraints. This may require the author to again, manually, adjust the output to conform to the desired field structure and length limit. The manual adjustment may lead to loss in accuracy of data and removal of important components from the output to ensure that the conformed output fits within the constraints of the desired webpage. Additionally, these changes may be compounded by data retries and iterative network transfers to manage the machine learning model's hallucinations and undesirable artifacts. Each of these issues add to latency-prone processes when authors want to explore multiple alternatives and iterate to find the optimal design for their webpage.

The techniques described in the specification improve upon the static copy and paste flows by performing an automated and validated process with the machine learning tool within an overall ecosystem of the website authoring environment. In particular, the system may receive a request from the user to perform a particular action and construct a prompt that includes a machine readable instruction for causing the machine learning model to output structured data. The system's constructs the prompt using data that identifies a collection, an item of the collection, and one or more data files for the item as specified by the request provided by the client device. The system may provide the prompt to the machine learning model, which produces candidate outputs.

The system validates each of the candidate outputs against the schema defined by the corresponding collection. Once the system validates each of the candidate outputs, the system may sanitize the model's outputs to fine tune the language, removing artifacts and other components that may create issues on the webpage, and render the sanitized output on the client device inline. The rendered output may be overlaid with one or more controls that allow the user to cycle through each of the different candidate outputs, accept one of the candidate outputs, or to regenerate different candidate outputs. In this instance, by creating candidate outputs from a single invocation of the machine learning model and applying rendered updates to the client device display, the system provides one or more technological improvements. For example, the system reduces network round trips, reduces overall CPU processing by preventing the server from having to conform the machine learning model's output to the schema, and reducing the number of retries performed by the user during their creation of the webpage.

In some implementations, website content is organized and structured by collections. A collection refers to a group of items organized for a particular purpose. The collection may be created, for example, to support a webpage, such as a blogpost, an event, a social media page, or other. Each collection provides one or more items that share a common schema. The one or more items may include, for example, data fields, data types, formats, required fields, disallowed fields, constants, and other data components. The fields may include text boxes such long or short texts, numbers, dates and times, images, assets, videos, references to other collections or other items, and one or more unspecified data fields. Generally, and as will be described below, when an author creates a webpage, the author may collect a collection that supports a webpage, or a series of collections that supports multiple webpages of a website.

In some examples, the system enables a designer to interact with a particular feature within the webpage on a client device. The designer or author may highlight a sentence, a paragraph, or multiple paragraphs on the webpage, and select a control to perform an action on the highlighted text. The action may include, for example, to change to a professional tone. This data is provided to the server, which works with the ML model to generate a set of structured output candidates that conform to the schema displayed on the webpage of the client device. The server may present the alternative outputs on the client device, that allow the user to select or accept the candidate output whose professional tone and expansive text matches to the idea.

As described herein, “machine learning” refers to a class of computational techniques and models, including to neural networks, transformer-based architectures, generative artificial intelligence, decision trees, support vector machines, clustering algorithms, and statistical learning methods. These techniques and models enable a computer system to automatically learn patterns or representations from data and improve performance on a given task without being explicitly programmed with task-specific rules. Machine learning systems may operate in supervised, unsupervised, semi-supervised, reinforcement, or self-supervised learning paradigms, and may be designed to perform a wide range of tasks such as classification, prediction, generation, translation, anomaly detection, and optimization across various data modalities, including text, images, audio, video, and structured data.

As described herein, a “model” refers to a computational system, algorithm, or structured representation used with a machine learning system. Examples of models include machine learning models, neural networks, transformer-based architectures, generative models, reasoning models, agentic systems, probabilistic models, statistical models, or rule-based systems. Models may be designed to process input data and produce outputs, predictions, decisions, actions, representations, or generated content. Models may operate under various learning paradigms, including supervised, unsupervised, semi-supervised, reinforcement, or self-supervised learning, and may be configured to perform tasks such as classification, regression, recommendation, anomaly detection, generation, translation, summarization, planning, decision-making, or multi-step reasoning across a range of data modalities, including structured data, text, images, audio, video, and sensor data.

As described herein, a “tool” refers to a discrete, callable unit of functionality that is registered within a platform registry and made accessible to one or more subsystems of an application. A tool may encapsulate a particular software capability, module, or feature, and may be invoked directly by a user or indirectly by an orchestration engine, assistant subsystem, or agentic process. A tool may be defined by a metadata specification that describes its functional purpose, input parameters, output types, and access constraints. Such metadata may further include contextual invocation rules or skill-gating requirements that limit tool execution based on user roles, system state, or external conditions. A tool may also be executed within the host application or may trigger remote services, APIs, or external modules. For example, a tool may perform a data transformation, retrieve content from a content management system, initiate a machine learning inference, or apply an automation feature to a digital asset. Tools may be atomic (e.g., performing a single function) or composite (e.g., orchestrating multiple underlying functions).

As described herein, a “module” generally refers to a discrete, encapsulated software unit that implements a defined subset of functionality within a larger system. For example, a module may include executable code, data structures, and associated interfaces that collectively enable the module to perform one or more tasks, operations, or services. In some implementations, a module may expose an API or inter-process communication interfaces through which other system components (e.g., agents, tools, or orchestration engines) may invoke module functionality. The module may be configured for local execution within an application runtime or for remote execution via a distributed service environment.

As described herein, a “collection” generally refers to a structured data container defined within a content management system. A collection may include one or more fields specifying attribute types and constraints, where each field is configured to store content of a designated type (e.g., text, image, reference, or relational identifier). The collection may further define a schema for a class of content items and may be programmatically bound to presentation templates for automatic instantiation of one or more web pages or components.

As described herein, a “component” generally refers to a reusable design element or grouping of design elements within a visual design environment. A component may include structural markup (e.g., containers, text elements, media placeholders), style definitions (e.g., Cascading Style Sheets (CSS) class associations), and behavioral attributes (e.g., event listeners, animations). Components may be instantiated multiple times across different pages, with instances linked to a common definition such that modifications to the component definition propagate to each instance.

As described herein, a “schema” generally refers to a structured definition that specifies the organization, attributes, and relationships of data within a system. A schema may define one or more fields, each field associated with a data type (e.g., text, integer, media, or relational reference), a set of constraints (e.g., required, optional, uniqueness), and optionally a linkage to other schemas or data sources. The schema operates as a blueprint governing how data is stored, validated, and retrieved by the system. A schema may be represented in a machine-readable format (e.g., JavaScript Object Notation (JSON), Hypertext Transfer Protocol (XML), proprietary markup), enabling programmatic generation of data containers and enforcement of structural consistency across instances. At runtime, the system may validate input data against the schema to ensure compliance and may utilize the schema to automatically bind data values to

As used herein, a “template” generally refers to a parameterized layout structure defining a presentation format for one or more data-driven pages. A template includes a set of design elements, placeholders, and binding definitions linking fields of a collection to corresponding elements of the layout. Upon execution of a publishing or rendering process, the template is programmatically combined with data from one or more collection items to generate fully populated output pages or views.

As used herein, “interactions” generally refer to declarative animation and behavior specifications that define dynamic changes to one or more elements of a rendered page in response to runtime events. An interaction may include a trigger definition identifying the initiating event, a set of target elements, and one or more animation or state-change operations to be applied to the target elements according to defined timing or sequencing parameters.

As used herein, a “trigger” generally refers to an event condition that initiates execution of an associated interaction or workflow. Triggers may include user-interface events (e.g., click, hover, scroll, page load) or system-generated events (e.g., content update, data submission). A trigger definition may specify the scope of the monitored condition and, upon detection of such condition, causes initiation of the corresponding action sequence.

As used herein, “logic” refers to a declarative workflow specification defining automated operations to be executed in response to system or user events. Logic may be represented as a sequence of interconnected nodes or steps, where each step specifies an action (e.g., data manipulation, API request, content update) and may include conditional branching, variable mapping, or external service integration. Logic is evaluated and executed by a backend workflow engine in response to event detection.

As described herein, an “agent” (or “ML agent”) generally refers to a software entity configured to operate autonomously or semi-autonomously within a computing environment by perceiving context, evaluating state, and executing one or more actions on behalf of a user or system. Agents may incorporate ML models (LLMs, LAMs), or other ML-based subsystems that enable adaptive behavior, natural language processing, decision-making, and dynamic invocation of system functionality.

Further, an “agentic” process or behavior generally refers to the autonomous or context-driven execution of actions by an agent, without requiring explicit step-by-step instructions from a user. For example, agentic functionality may include interpreting natural language or multimodal prompts based on processing input queries submitted by a user. In other examples, agentic functionality includes determining relevant goals or sub-tasks, invoking software capabilities (e.g., tools, functions, external services registered) within a platform registry, and sequencing or chaining such invocations until an objective is satisfied.

As discussed in detail below, the machine learning techniques disclosed herein may be provided to augment, streamline, and/or improve various aspects of a web experience platform that allows users to perform various types of actions relating to website development (e.g., access, design, develop, build, access, manage, analyze). Through use of machine learning, the techniques disclosed herein may allow users to generate website or webpage content that conforms to structure and schema of a designated webpage. For example, in a ML-enabled web experience platform, when a user requests for changes or modification to components of a webpage, the machine learning may be configured to create new text, images, and other relevant content based on the user text, prompt, selection, or other input provided by the client device.

Implementations of the present disclosure are described in further detail herein with reference to the creation of content for webpages. In some implementations, the techniques described in this present disclosure are applicable to the creation of content for other application, such as applications, emails, product designs, brochures, or other products, to name some examples.

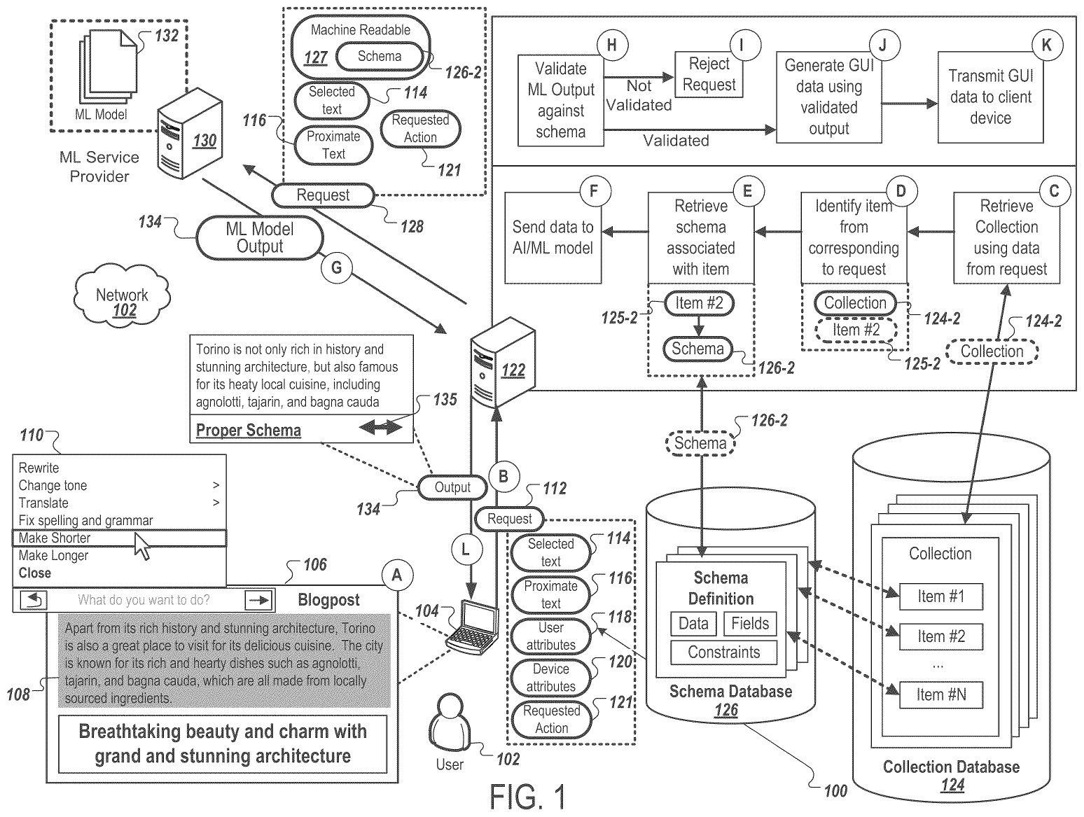

FIG. 1 is a block diagram of an example system 100 that performs techniques for generating website content using machine learning. The system 100 may include one or more servers or computers connected locally or over a network. The system 100 may include a network 102 that may be, for example, a local network, a Wi-Fi network, an intranet, an internet connection, or some other connection that enables the system 100 to communicate, e.g., transmit and receive, with various databases and one or more external devices. In some cases, the system 100 may include one or more databases. In some implementations, the system 100 may be performed by a cloud computing system over a network.

FIG. 1 illustrates various operations in stages (A) through (L), which may be performed in the sequence indicated or in another sequence. For instance, some of the stages may be performed concurrently, in part or in whole, may be skipped, or may be performed in different orders, e.g., stage (A) may be performed after stage (B).

As illustrated in system 100, a user 102 may seek to generate webpage content using a client device 104. The user 102 may be, for example, a developer of a webpage seeking to access a webpage, a user seeking to access information from the webpage, and an administrator seeking to validate a configuration of the webpage. The user 102 may communicate with the system 100 through their respective client device 104. The client device 104 may include a personal computer, a workstation, a handheld device, a portable table, a smart phone, or any other type of device capable of communicating over a network to the server 122. The client device 104 may communicate with the server 122 over the network 102 using any form of communication protocol, e.g., Hypertext Transfer Protocol (HTTP) or Transport Layer Security (TLS).

In some examples, the client device 104 may execute a web-based application or a native application that provides an interactive interface to the user 102. In some examples, the client device 104 may communicate with the server 122 over a network 102 through one or more application programmable interfaces (APIs), for example, to request webpages, retrieve configuration information, retrieve schema information, retrieve collection information, or perform another request. The one or more APIs may enable a single webpage interaction as well as bulk or batched webpage requests. In some cases, the one or more APIs enable streaming of data between the client device 104 and the server 122 for real time or incremental GUI updates to the particular webpage.

During stage (A), the client device 104 may present a GUI that enables the user 102 to access a particular webpage, such as webpage 106. Moreover, the GUI enables the user 102 to perform an action on the particular webpage and transmits a request 112 to the server 122 to performing the action. For example, the request 105 may specify an action to perform on a portion of text on the webpage. As illustrated in the example of FIG. 1, the actions may include, for example, rewriting a portion of text, changing tone of the text, translating the text to another language other than the language displayed, fix spelling and grammar of the text, make the text shorter, or make the text longer. In some example, the user 102 may specify a webpage by providing a uniform resource locator (URL) for the webpage or website including one or more webpages. In response for accessing the website, the user may desire to interact with one or more components of the webpage to adjust the text, the structure, the data fields, the field items, the layout, or one or more other portions of the webpage.

In the example of FIG. 1, the user 102 may highlight text 108. The text recites “Apart from its rich history and stunning architecture, Torino is also a great place to visit for its delicious cuisine. The cite is known for its rich and hearty dishes such as agnolotti, tajarin, and bagna cauda, which are all made from locally sourced ingredients.” The user 102 may select “make shorter” from the action window 110 displayed on the client device 104. In response, the client device 104 may generate the request 112.

The client device 104 may generate the request 112 according to the indication provided by the user 102. The request 112 may include, for example, the selected text 114, the proximate text 116, a user attributes 118, and device attributes 120. The selected text 114 may include a text segment or a portion of text displayed on the webpage 106 of the client device 104 that was highlighted or interacted with by the user 102. In some cases, the selected text 114 may include a representation of the text that was interacted with by the user 102 on the webpage 106. The representation of the text may include, for example, a Hypertext Transfer Protocol (HTTP) data or rich text. The representation of the text may also include locational positions of the text on the webpage, such as pixel locations or other information. In some cases, the selected text 114 may include webpage attributes. The webpage attributes may include, for example, an identifier associated with the collection type or identifier associated with the content to which the highlighted text belongs, an identifier associated with an item within that specified collection, an identifier associated with a field in that particular item, and an identifier associated with a schema used for that webpage 106. The identifiers may represent the structural components of the webpage 106 that enable the server 122 to identify those components in the corresponding databases.

The user attributes 118 may include, for example, a session identifier, a user identifier, geolocational data of the user 102, username and password of the user 102 for authenticating with the server 122, and other information that identifies the user 102. The device attributes 120 may include, for example, an internet protocol (IP) address of the client device 104, a media access control (MAC) address of the client device 104, network characteristics utilized by the client device 104, operating system of the client device 104, browser used on the client device 104, and communication protocols used by the client device 104, to name some examples.

In some implementations, the request 112 may include proximate text 116. The proximate text 116 may include context surrounding the selected text 114. The context surrounding the selected text 114 may include, for example, an amount of text that proceeds and follows the selected text 114, one or more blocks of data surrounding the selected text 114, metadata of the webpage 106, and metadata of the website that includes the webpage 106. The amount of proximate text 116 to include may depend on the amount of text shown on the webpage 106 and the amount of text on the webpage 106.

In some implementations, the requested action 121 may specify the operation the user 102 requests to be performed on the webpage 106 on the selected text 108. The operation may be, for example, rewrite, change tone, translate, fix spelling and grammar, make shorter, make longer, and generate additional text. In some implementations, the requested action 121 may specify the number of candidate outputs to be generated by the ML model. In some implementations, the requested action 121 may specify whether the output should be provided as a preview in the webpage 106 or whether the output should automatically be entered into the webpage 106.

During stage (B), the client device 104 transmits the request 112 over the network 102 to the server 122. The server 122 may receive the request 112 over the network 102. In response to receiving the request 112, the server 122 may initiate the processes of analyzing the request to determine the action to be performed on a set amount of text, to name some examples. In some implementations, the server 122 may queue the request 112 for processing in a distributed task manager that allocates webpage generation tasks. The server 122 may perform webpage generation tasks for a variety of client devices. As a result, the server 122 may validate the request 112 to determine that the request 112 was submitted in the proper format, with the proper parameters, and that the data include in the request 112 matches an expected schema.

In some implementations, the server 122 may receive the request 112 and parse the received request 112. In particular, the server 112 may extract the user attributes 118, the device attributes 120, the selected text 114, the proximate text 116, and the requested action 121. In some cases, the server 122 may perform additional verification checks to standardize the data provide in the received request 112. The server 122 may generate a record according to the received request 112 and store the record in memory with a time stamp. For example, the server 122 may recognize from the received request 112 the selected text 114, the proximate text 116, and the requested action 121 to be performed on the selected text 114. In another example, the server 122 may recognize whether the request 112 transmitted was authorized by analyzing the user attributes 118 and the device attributes 120, accordingly. If the server 122 determines that any information is missing from the received request 112, then the server 122 may fill in the missing information using default information and logs the missing information with the record in memory.

During stage (C), the server 122 may retrieve the corresponding collection utilized to render the webpage 106 on the client device 104 using data extracted from the request 112. In particular, the server 122 extracts the various identifiers from the selected text 114. The various identifiers include, for example, the collection identifier, the item identifier, a field identifier, and a schema identifier. Each of these identifiers enable the server 122 to resolve the structural components used to render the webpage 106 on the client device 104. The webpage 106, as designed by the user 102 or in the process of being designed by the user 102, is bound to the constraints, rules, or limitations of the corresponding collection, field, and identifier, and which the underlying schema governs.

Using the extracted collection identifier, the server 122 may query the collection database 124 to locate the target collection. If the collection identifier is missing from the request 112, then the server 122 may infer the type of collection being used on the webpage 106. The type of collection being used on the webpage 106 may be inferred from, for example, the URL of the webpage 106 displayed on the client device 104 or the metadata of the webpage 106. The URL of the webpage 106 or the metadata 106 allows the server 122 to correlate to a collection stored in the collection database 124. The server 122 may provide the URL of the webpage 106 or various data from the metadata 106 of the URL to the collection database 124. The collection database 124 may return the collection that matches to the URL or the various data or may return a pointer that provides the server 122 access to the collection within the collection database 124, such as via an index.

The collection database 124 may include a group of collections that have been generated by various users and websites that have interacted with the server 122. Each collection entry in the collection database 124 may include a set of items that conform to a schema for that collection, and each item may include metadata that describes the item. The collection entry may include a key that defines the items, fields, and constraints of that corresponding collection entry. The collection entry may include a set of relationships that describe one or more items connecting to other items in other collections. As a result, the collection database 124 may store the collection entries, data describing the entries, and data describing the collection entries connection to one or more other collection entries.

As illustrated in the system 100, the server 122 may retrieve collection 124-2 from the collection database 124. The collection 124-2 may include a set of items 1 through N. The server 122 may retrieve the collection 124-2 using the collection identifier from the request 112. The collection 124-2 may be provided to the next stage for processing by the server 122.

During stage (D), the server 122 may identify the item using the extracted data from the request 112. In particular, the server 122 may utilize the item identifier included in the request 112 to identify which item, e.g., item 1 though N, corresponds to the item that user 102 interacted with the text 108 displayed on webpage 106. In this instance, the item identifier functions as a key to access the item from the collection 124-2 of the collection database 124.

The server 122 may verify that the referenced item belongs to the collection 124-2 and that the field identifier extracted from the request 112 to a field defined for that item's collection. In some cases, the server 122 may retrieve current field values, e.g., the selected text 114, for context, the item's version identifier to ensure it matches with the item shown on the webpage 106. For example, as illustrated in the example system 100, the server 122 may access item 125-2 from the collection 124-2 using the item identifier extracted from the request 112.

During stage (E), the server 122 may retrieve a schema from a schema database 126 that supports the schema of the item retrieved in stage (D) and the schema of the collection in stage (C). In some implementations, the schema database 126 may include various schema definitions that support the collections maintained and stored in the collection database 124. Each schema definition may specify the structure that items in the corresponding collection must satisfy. The schema definition may include, for example, field names, field types, data values, formats, date and time, constraints, and relationship metadata. The relationship metadata may describe references to one or more other schemas, in the event that a collection references one or more other collections. In some implementations, the schema database 126 may include schema versions. The schema versions may be included for version control history, which may include version control for managing schemas that may change over time.

In some implementations, the server 122 may ensure that the collections and the corresponding items abide by the corresponding schema. For example, in the example of system 100, the server 122 identifies schema 126-2 from the schema database 126 using the identifier extracted from the request 112 and recorded with the collection 124-2. The server 122 may verify that the item 125-2 belongs to the collection 124-2 and that the field identifier referenced in the request 112 corresponds to the field defined by the schema 126-2.

In some implementations, the server 122 may verify that the schema used by the client device 104 on the webpage 106 matches the version of the schema used for the collection 124-2. The schema used by the client device 104 on the webpage 106 should match to the schema 126-2. If the server 122 determines that schema supporting the webpage 106 matches the schema 126-2, which indicates that the webpage 106 is supported by the collection 124-2, then the server 122 indicates that the webpage 106 is properly created. If the server 122 determines that the schema supporting the webpage 106 matches the schema 126-2 does not match, then the server 122 marks the schema supporting the webpage 106 as outdated. In response to marking the schema supporting the webpage 106 as outdated, the server 122 may provide a prompt to the user 102 at the client device 104 on the webpage 106 to perform a refresh of the webpage 106 or to reload the application on the client device 104 that displays the webpage 106. The server 122 prompts the user 102 of the client device 104 to refresh of the webpage 106 or reload of the application on the client device 104 in order to perform a schema sync between the schema 126-2 and the outdated schema being applied at the client device 104 for supporting the webpage 106. The server 122 may provide the schema 126-2 upon the user 102 performing the schema sync, causing the client device 104 to automatically update the webpage 106 with the correct schema 126-2.

Following the execution of the schema sync, the server 122 may continue with executing the requested action 121. The selected text 108 is rebound to the webpage 106 and the server 122 proceeds with generating a prompt for submission to the ML Model. As a result, this approach allows the client device 104 to interact with text on a webpage 106 with an outdated schema, synchronize the schema for the webpage 106 to an updated schema, and prevent the loss of text that was interacted with on the webpage 106 with the outdated schema.

During stage (F), the server 122 generates a machine readable instruction 127 and inserts the machine readable instruction 127 into a model request 128. The machine readable instruction 127 may encode the expected structure of the ML model's response by incorporating the schema 126-2 into the model request 128. The machine readable instruction 127 may specify, for example, permitted field names and permitted field types for the target item, various formats and constraints specified by the schema 126-2, any allow output rules, and constraint rules. As a result, the machine readable instruction 127 may cause the ML model to output a structured output that conforms to the specified data types identified by the machine-readable instruction 127. For example, the machine readable instruction 127 may include a JSON instruction, readable by the ML model.

In some cases, the server 122 may include other items from the corresponding collection 124-2 to include the model request 128. The other items may include, for example, the top three most recent items used in the collection 124-2, or all of the items used in the collection 124-2. This allows the model request 128 to incorporated with additional context to enhance the ML model's understanding of the data in the machine readable instruction 127 and other data in the model request 128.

The model request 128 may include the machine readable instruction 127 and the selected text 114 and the proximate text 116 from the webpage 106. Additionally, the model request 128 includes the requested action 121 to perform on the selected text 114, and any parameters related to the performance of the request 128. The parameters may include, for example, the number of candidate outputs requested for or the language with which the ML model is to provide the output. The number of candidate outputs requested for may be dictated by the server 122 or requested for by the user 102 when interacting with the client device 104. In response to generating the model request 128, the server 122 may prepare the model request 128 for transmission to the ML server provide 130.

The ML service provider 130 may be a server system or cloud computing platform that provides access to one or more ML models 132, such as LLMs. The server 122 and the ML service provider 130 may be implemented as separate systems or may be integrated in a single system. For example, the ML service provider 132 may be a third-party service or may be managed and operated by the same party as the server 122.

The model request 128 includes information to cause the ML model 132 to provide a narrative, e.g., description, explanation, interpretation, of the action 121 to be performed on the selected text 114. The server 122 may provide the request 128 to the ML service provider 130 over the network 102. The ML service provider 130 may provide access to one or more ML models 132, such as LLMs.

During stage (G), the ML service provider 130 receives the model request 128 and generates one or more candidate structured outputs in response. The ML service provider 130 may parse the model request 128 and extract the data from the request 128, e.g., extract the machine-readable instruction 127, the selected text 114, the proximate text 116, the requested action 121, and any generation parameters. The ML service provider 130 may provide the extracted data as input to one or more ML models 132 to generate the one or more candidate outputs requested, e.g., a description in the format specified by the machine readable instruction 127 of a result of the action performed on the selected text 114 and potentially the proximate text 116. In response, one of the ML models 132 may generate the ML model output 134 that includes the one or more candidate outputs as requested. Each candidate output may include, for example, a structured JSON object or an array of JSON objects that conforms to the machine-readable instruction 127. Each candidate output may include one or more permitted fields of data corresponding to the identified item on the webpage 106.

In some implementations, the ML model 132 may process the data from the model request 128 to interpret the meaning of these input data types. Generally, an ML model 132 (e.g., LLM) seeks to interpret and generate a narrative, e.g., human readable text, by analyzing various patterns across vast amounts of data. The ML model 132 may generate a coherent and contextually appropriate narrative of the extracted data from the model request 128. In some cases, the ML model 132 may also provide summaries of the extracted data from the request 128. In some instances, the ML model 132 generates a response in a designated language specified by the request 128, e.g., such as a language of the user 102. For example, the ML model 132 may generate a rewritten paragraph, a shorter summary, a translation into a designated language, a tone adjusted variation, each include encoded values for the appropriate fields. In such examples, when the ML model 132 generates multiple outputs, each output is distinct from one another.

The ML model 132 may create the ML model output 134 that satisfies the layout, formatting, or other characteristics according to the data specified in the machine readable instruction 127. For example, the ML model 132 may color code certain portions of the text, generate the text with an emotional tone, personalize or tailor the generated text according to the preferences specified by the schema 126-2 and the requested action 121. Each candidate output conforms to the requirements and constraints specified by the machine readable instruction 127.

The ML service provider 130 transmits the ML model output 134 to the server 122 over the network 102.

During stage (H), the server 122 may receive and validate the ML model output 134. For each candidate output contained in the ML model output 134, the server 122 may perform various functions to ensure the ML model output 134 conforms to the schema 126-2. For example, the server 122 may verify that each candidate output adheres to the guidelines in the schema 126-2, such as, field presence, types, formats, required fields, maximum lengths, and other data components. In some examples, the server 122 may perform sanitization to ensure that the text in each output candidate does not include inappropriate language, constrained according to the context indicated in the proximate text 116, and the language is human readable. In some examples, the server 122 may also verify that each candidate output includes the appropriate amount of white space, is written in the desired language, and follows appropriate formatting protocols.

During stage (I), the server 122 may reject the request 112 if no candidate output from the ML model output 134 passes the validation during stage (H). In this case, the server 122 may generate a structured error response to provide to the client device 104 that identifies the particular failure or the particular rule that failed. For example, the server 122 may generate the structure error response that includes “Field value exceeds maximum length,” “disallowed data value in field”, or “Error output by model,” to name some examples. In some cases, the server 122 may generate the structure error response if the ML model 132 hallucinated and/or produced an output that does not follow the machine-readable instruction 127.

In some implementations, the server 122 may include one or more recommendations to provide to the user 102 on retry. This may include, for example, instructions to recommendations to a change a field in the selected text 114, instructions to revise where in the webpage 106 to perform the selected text 114, or instructions to change the selected option from the window 110 to another option, e.g., change from “Make Shorter” to “Make Longer”. If some but not all of the candidate outputs fail the validation during stage (H), then the server 122 may discard the candidate outputs that failed and the server 122 may include a notification to provide to the user that indicates which of the candidates failed and why those candidates failed. At the same time, the server 122 may continue with any validated candidates.

If the server 122 determines that one or more candidate outputs from the ML model output 134 pass validation, then the server 122 may produce a cleansed data set for those validated candidate outputs. The cleansed data set may include, for example, normalized data that is uniform across each of the candidate outputs and meets the desired text and formats specified by the machine-readable instructions 127. In particular, the server 122 may validate or clean the candidate output by determining that the language is accurate and does not include any security risk.

During stage (J), the server 122 may generate GUI data for each validated candidate output for the webpage 106. The GUI data for each validated candidate output may include, for example, the values for each validated candidate output, navigation controls to allow the user to select between or cycle through each validated candidate output, identifiers for each validated candidate output, e.g., page identifiers, field identifiers, collection identifiers, item identifiers, and schema identifiers. The GUI data may also include a markup version that conforms to the schema 126-2 for rich text version

During stage (K), the server 122 may transmit the GUI data for each validated output to the client device 104. For example, the transmitted GUI data transmitted as output 134 may be a compact JSON data structure that causes the client device 104 to render the data on the webpage 106. With multiple validated candidates, the output 134 includes a set of validated candidates and metadata for cycling between the set of validated candidates. The GUI data may include a cycler 135 that allows user 102 to cycle between each of the validated candidates.

During stage (L), the client device 104 may receive and display the GUI data from the output 134 on the webpage 106. As illustrated in the example of system 100, the new output 134 includes a candidate with a shortened version of the text 108. The shortened version recites “Torino is not only rich in history and stunning architecture, but also famous for its hearty local cuisine, including agnolotti, tajarin, and bagna cauda.” This shortened text may be applied inline on the webpage 108 and presented to the user 102 for review, or whether the user 102 desires to cycle to another validated candidate output.

The system may repeat the process discussed above for stages (A) through (L) each time user 102, client device 104, or server 122 triggers the creation of an action to be performed on a webpage of client device 104 or on any other client device that communicates with the server 122. Additionally, the process of stages (A) through (L) may be performed independently and in parallel to provide different webpage changes for each of multiple different client devices that each have their own webpages loaded and have their own webpage views displayed, with different text and different actions being performed on their respective text.

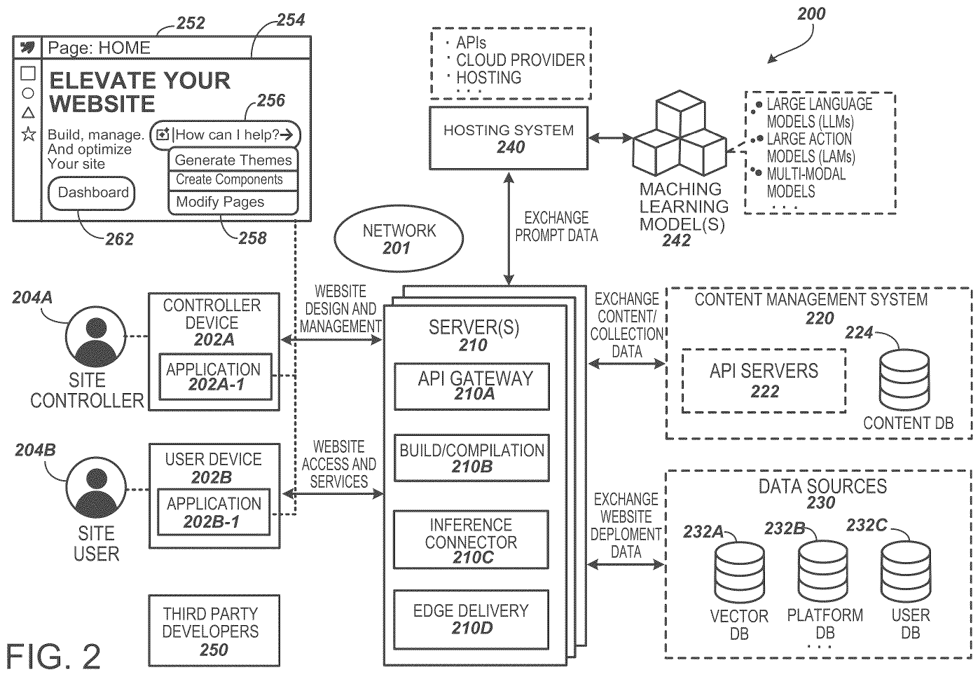

FIG. 2 illustrates an example of a web experience platform (WEP) 200 for enabling website development. In general, the website development capabilities enable users to design digital experiences, ingest user-defined digital experience specifications, transform the user-defined digital experience specifications into deployable artifacts, and distribute resulting web experiences over a network. For example, the WEP 200 may receive design-time input that specifies pages, components, styles, interactions, and content, compile or otherwise process that input (e.g., assistance from one or more ML models) into executable markup, code bundles, media, and metadata. The WEP 200 may store intermediate and final artifacts in multi-tenant data stores, identify published experience and associated application services to site visitors with edge-based delivery resources. This environment may further support content management, e-commerce, membership gating, localization, extension APIs, among other types of functionality.

In general, system 200 leverages ML within a content-management, schema-constrained WEP to address computer-centric problems in generating, selecting, and rendering webpage modifications at scale. System 200 obtains structured inputs defined by a content schema and associated metadata (e.g., section-level or hierarchy information), constructs constrained prompt data or model inputs from those structures, and applies trained ML models to produce candidate outputs that are validated for structural compatibility before use in the build and delivery pipeline. By grounding ML operations in machine-readable constraints and executing only schema-compatible results, system 200 improves computer operation in distributed web systems (e.g., by reducing integration failures, avoiding incompatible markup, limiting unnecessary network transfers, and enabling low-latency rendering of a single, selected variant on the client device). The WEP further augments and/or improves various aspects of the web development functionality through use of one or more ML models 242. These ML models 242 may be invoked at multiple, independent junctures of WEP workflows to streamline, accelerate, and/or augment tasks that have traditionally needed manual development effort.

For example, a site controller operating the controller device 202A may access an ML interface 256 (e.g., presented as a text-chat, voice, or multimodal panel within the existing design canvas) to submit natural language prompts that cause the one or more ML models 242 to generate entire page layouts, reusable components, helper functions, and the corresponding markup or code artefacts without leaving an authoring environment. After a site has been deployed, other ML interfaces may be used to request automated regeneration or modification of components in a manner that preserves data bindings and collection schemas maintained by a content management system (CMS) 220. This reduces the risk of breaking existing CMS-driven pages.

In another example, a site controller 204A or site user 204B administrator may invoke an ML assistant exposed through a dashboard widget to obtain step-by-step guidance on operational tasks (e.g., configuring localization variants, setting up gated-membership rules, or troubleshooting performance settings) based on conversational queries rather than navigating multiple configuration panels. Each of these interfaces may simply route prompt data to external model resources (e.g., hosting system 240) and returns model output to the same front-end context, the ML functionality may be layered onto different phases of the website-development lifecycle without requiring structural changes to the underlying build, orchestration, or delivery services.

The WEP 200 includes various computing and data elements, examples of which are shown in FIG. 2. These elements generally exchange data over a network 201. A controller device 202A represents an authoring endpoint operated by a site controller. A user device 202B represents a consumption endpoint operated by a site user. Additional third-party developer devices 250 may interact with extension tooling.

One or more servers 210 enable centralized functionality associated with the WEP 200. The one or more servers 210 may correspond to the server 122 shown in FIG. 1. As such, the server 122 may perform the functionality described with respect to the one or more servers 210. Servers 210 further include API gateways 210A, orchestration modules 210B, build/compilation modules 210C, inference connector modules 210D, and edge-delivery modules 210E, each of which cooperate to perform request handling, background workflow, artifact generation, machine-learning integration, and content delivery network (CDN)-style dissemination, respectively. CMS 220 encloses API servers 230 and a content database 212B. Further, data sources 230 includes persistent stores, such as vector database 232A, platform database 232B, user DB 232C. A hosting system 240 exchanges prompt data and model output with one or more ML models 242.

In more detail, the site controller 204A may operate a controller device 202A (e.g., desktop computer, laptop, tablet, or similarly capable computing terminal). The controller device 202A executes an authoring application 202A-1 that communicates with WEP 200 over network 201. Using the authoring application 202A-1, the site controller may generate, import, or modify design-time assets (e.g., page structures, component libraries, style sheets, interaction timelines, and data bindings) and submit corresponding save, build, or publish requests to the servers 210. Controller device 202A may render the authoring application in a browser context, a native container, or another runtime environment, and may exchange design-and-or-maintain website-deployment data with the platform in real time or near-real time.

A site user 204B may operate a user device 202B (e.g., desktop computer, laptop, tablet, smartphone, set-top box) executing a runtime application 202B-1 that requests and renders published site assets delivered by the servers 210. The user device 202B may load static pages, dynamic CMS-backed content, e-commerce flows, membership-gated resources, or localized variants, depending on how the site was configured by the controller. Interactions initiated from the user device 202B may result in access-and-or-interact website-deployment data being exchanged with the servers 210, with optional personalization, authentication, or analytics processing performed along the way.

As shown in FIG. 2, the authoring application 202A-1 presents a designer interface 252 that provides access to visual tools enabling a site controller 204A to construct and/or alter a page 254 without direct manipulation of source code. Within interface 252 a component pane may surface reusable elements such as component 262, and a canvas or viewport may preview the evolving layout in real time. An ML interface 256 permits the site controller 204A to issue natural language prompts or other inputs to interact with the one or more models 242 via hosting system 240. Interface 256 may be implemented in various ways, such as a chat panel, voice overlay, multimodal widget, among others. Responsive model output may drive ML-assisted functions 258, which may include, for example, automatically generating page sections, refactoring existing component 262 for accessibility or localization, producing CMS-compatible schema suggestions, or inserting client-side logic templates. Depending on configuration, similar ML interfaces may also surface within runtime application 202B-1, allowing site users to obtain guided assistance or perform management tasks through conversational interaction.

One or more servers 210 operate as the execution core of WEP 200, receiving network traffic from external actor devices, coordinating internal workflows, invoking machine-learning resources, and emitting deployable or runtime assets. Although depicted as a single logical block, servers 210 may be implemented as a co-located cluster, a distributed micro-service mesh, or a cloud-hosted arrangement that scales elastically with demand.

The servers 210 incorporate a set of software modules configured to cooperate through message queues, RPC calls, or other service-bus mechanisms. At a high level API gateway modules 210A handle synchronous ingress. An orchestration tier (not shown in FIG. 2) manages background or long-running tasks. Build/compilation modules 210B convert design input into deployable artifacts. An inference connector layer 210C broker prompt exchanges with the hosting system 240. Edge delivery modules 210D stage static and dynamic resources for low-latency distribution. Each module may be containerized, serverless, or otherwise independently deployable, allowing updates to be rolled out without interrupting the WEP 200.

API gateway modules 210A perform various functions, such as terminating Transport Layer Security (TLS), validating JavaScript Object Notation (JSON) Web Tokens, and expose Representative State Transfer (REST), Graphical Query Language (GraphQL), or WebSocket interfaces that client applications call when saving designs, fetching CMS content, or running administrative queries. They may apply per-workspace or per-site rate limits, translate external resource identifiers into internal shard keys, and inject correlation metadata into each request for downstream tracing. In zero-trust configurations, the API gateway modules 210A may also perform mutual-TLS handshakes with edge nodes or developer command line interfaces (CLIs) before forwarding traffic onto the internal mesh.

Build/compilation modules 210B retrieve development snapshots, CMS bindings, and theme settings, then emit hashed asset bundles, pre-optimized image variants, framework-specific component libraries, and search-index manifests. A dependency graph may be used to identify pages or assets are invalidated by a change so that a full rebuild is avoided. Unchanged artifacts may also be linked from previous build versions. Output objects are written to a versioned S3-style bucket, tagged with a content hash and build-number metadata, and handed off to edge-delivery modules for global propagation.

Inference connector modules 210C assemble prompt payloads that may include design fragments, content snippets, schema fingerprints, and user-authored questions. The inference connector modules 210C may sign each request with a per-workspace API key, apply temperature or max-token policies set by workspace administrators, and/or dispatch prompts to an external model endpoint over authenticated (e.g., HTTP/2) channels. Inference connector modules 210C also parse received model output into typed actions, such as “generate component,” “rewrite copy,” or “suggest accessibility fix.” These parsed outputs may be queued back to orchestration modules or streamed directly to user devices.

Edge delivery modules 210D take artifacts produced by the build/compilation modules 210B and replicate them across geographically distributed points of presence. Assets may be version-pinned so a canary rollout may serve the new build to a percentage of traffic while the prior build remains active for the remainder. Edge workers may also execute JavaScript or WebAssembly to perform request-time tasks (e.g., cookie-based A/B routing, on-the-fly image resizing, or server-side rendering of personalized fragments before returning a response that is cached for subsequent requests).

The architecture of the servers 210 enable various applications of ML models 242 in relation to different web development workflows accessible through the WEP 200. In some implementations, the servers 210 enable an authoring workflow in which a newly added component is propagated from the design canvas to production in near real-time. For example, when a controller drags a “testimonial” component onto the canvas, the interface 252 emits a JSON delta via WebSocket to API-gateway modules 210A. Orchestration modules enqueue a build job, and the build/compilation modules 210B regenerate only the affected page bundle while reusing shared CSS and runtime libraries. Inference connector modules 210C send the component copy to ML models 242 (e.g., LLM) and requests tone-consistent rewrites. Model output data is then streamed back to the interface 252 for user review and approval. The edge delivery modules 210D pre-warm caches for the updated path, enabling publishing to be completed quickly (e.g., under a second).

In some implementations, the servers 210 enable a live component-refactor workflow that automates accessibility or structural updates across an existing site. A site controller 204A may type “convert nav bars to an accessible drop-down” into ML interface 256. In response, inference connector modules 210C package a prompt containing the site's navigation markup and audit results, retrieve refactored HTML and a, and forward the patch to build-and-compilation modules 210B. After incremental compilation, edge-delivery modules 210D push the new build while invalidating only nav-bar assets. A rollback pointer to the previous build is retained for instant reversion if post-publish tests fail.

In some implementations, the servers 210 enable an administrative guidance workflow that delivers conversational, ML-generated instructions for platform configuration tasks. For example, a site user 204B may interact with a voice widget to ask, “How do I enable multi-language support?” In this example, a voice clip may be transcribed on the user device 202B and posted to API-gateway modules 210A. Inference connector modules 210C query one or more ML models 242 (e.g., knowledge base aware model) that returns a checklist of localization steps plus one-click mutation calls. Orchestration modules then create a location workspace, build/compilation modules 210B obtain locale variants, and edge delivery modules 210D begin serving Accept-Language aware routes. This workflow allows the task to be completed without manual navigation through multiple settings screens.

CMS 120 manages structured content that populates pages, components, and dynamic lists served by WEP 200. The system lets a site controller define collections, fields, and localized variants, then stores and surfaces that content so that build and runtime processes may merge it with design artifacts. During machine learning workflows prompts may be enriched with relevant collection entries or schema information. Model output may be validated against the same schema to ensure that any generated markup stays coordinated with stored data.

CMS 220 further includes API servers 222 and content database 224. The API servers 222 expose read and write endpoints that the design canvas, build pipeline, and runtime site all consume. The content database 224 stores collection items, draft, locale variants, and reference links (e.g., in a multi-tenant partition so that different workspaces remain isolated). These elements of CMS 220 let other modules in WEP 200 (e.g., modules of servers 210) treat content as a typed data source rather than raw text.

API servers 222 may implement REST and GraphQL methods for creating collections, uploading media, managing localization, and querying entries at build or request time. Requests enter through API gateway modules 210A and are routed to the appropriate microservice shard. Each call is checked against workspace roles so that only authorized users or processes may insert or mutate content. The servers 210 also transmit events that orchestration modules may listen to in order to trigger incremental rebuilds or cache purges.

Content database 224 is a multi-region document store that persists collection schemas, field values, slug indexes, and locale mappings. Each write operation may be versioned, allowing rollback if a site controller 204A accidentally deletes or changes an entry. The content database 224 supports full-text and faceted search so that runtime pages may query on reference fields without loading entire collections. It also stores media metadata that edge delivery modules 210D may use for responsive image selection.

Interaction between API servers 222 and content database 224 may follow a strict commit path. For example, API servers 222 validate incoming payloads against collection schemas, transform the payloads into storage records, and write them to content database 224 in a transaction that ensures referential integrity. When data changes the servers publish a change event to orchestration modules. Build/compilation modules 210B may pull the updated entries, regenerate only the affected pages, and write new artifacts to the build repository. Edge delivery modules 210D receive a signed cache bust instruction so that users see the updated content without delay. This communication loop ensures design, content, and deployment states are aligned even when machine learning models generate or modify content through the same APIs.

Data sources 230 provide a storage layer that underpins content retrieval, machine learning context, and runtime personalization for WEP 200. Databases included in the database sources 230 may sit outside the servers 210 so it may scale storage capacity independently of compute demand. For example, read and write operations flow through API gateway 210A or orchestration tasks, and change events propagate to build or edge services so that newly stored records appear in published sites without manual intervention. During prompt generation, the inference connector 210C enriches requests with context fetched from these stores, and after model inference the same stores are updated or queried to confirm that generated output aligns with existing schemas.

Vector database 232A stores high-dimensional embeddings that represent component code snippets, CMS entries, design tokens, and knowledge base documents. The vector database 232A supports approximate nearest-neighbor search so the inference connector may retrieve semantically similar records in milliseconds. Embeddings are regenerated during build or on demand when a large batch of content changes. The store also tracks embedding versions so model prompts always receive context that matches the active design or content revision.

Platform database 232B holds project metadata such as workspace settings, build history, billing status, feature flags, and role assignments. Each workspace or site occupies a logical partition that isolates records while still allowing cross-workspace queries for administrative analytics. The database maintains foreign keys to build artifacts in object storage and to content items in CMS 220, which lets server modules assemble a complete view of a project without performing fan-out requests.

User database 232C records site member accounts, authentication tokens, membership tiers, and e-commerce order history. Access tokens generated by API gateway 210A map to rows in this store, allowing edge delivery modules 210D to evaluate gating rules during request processing. The user database 232C also captures engagement metrics such as last login time or page view counts, which may feed personalization or analytics dashboards.

The databases discussed above operate together through shared identifiers and event streams to maintain consistency across the platform. When a controller publishes a new collection item the CMS writes the entry to content database 224 and emits an event that triggers embedding generation in vector database 232A. The same event updates index pointers in platform database 232B so build modules may link the new content to its deployment record. If the item is member-restricted, a policy pointer is stored in user database 232C so edge delivery modules may enforce access at request time. This coordinated flow ensures that machine learning prompts receive up-to-date context, model output respects schema constraints, and published pages honor all access and personalization rules.

Hosting system 240 provides a managed inference service that receives prompt data from server modules and returns machine generated output used to augment website design, build, and runtime tasks. The hosting system 240 may allocate compute resources, schedule model workloads, enforce request quotas, and logs usage metrics. Prompt requests may include design fragments, CMS records, or visitor questions. Response payloads may contain generated code snippets, rewritten copy, layout suggestions, or operational guidance that the platform may apply without manual intervention.

Hosting system 240 integrates with the WEP 200 through a set of network accessible endpoints that may be reached by direct API calls, by cloud provider private links, or by a customer managed hosting arrangement. The inference connector 210C authenticates each request with an API key, signs payloads, and posts them to an endpoint path that selects a specific model or model version. The hosting system 240 may reside in a public cloud region, in a dedicated tenancy, or in an on-premise cluster that meets data residency requirements. Configuration flags allow workspace administrators to choose among these connectivity modes without changing application code.

Machine learning models 242 implement the inference logic that generates the information used by the WEP 200. The models may be large language models (LLMs) that excel at natural language generation, large action models (LAMs) that plan multi step tasks, or multimodal (MM) models that accept and emit combinations of text, code, or image embeddings. Each model may be versioned and measured for token usage, latency, and accuracy. The hosting system 240 may route traffic to a single model or to an ensemble of models depending on the prompt type and workspace policy.

Machine learning models 242 operate inside the hosting system 240 in containerized runtimes, e.g., runtimes that that expose uniform gRPC and REST interfaces. The hosting layer may handle model loading, weights decryption, warm-up sequences, and autoscaling. It also injects guardrail middleware that checks prompts for policy compliance and truncates or redacts disallowed content. Model output is streamed back to WEP 200 in an event format that preserves token order so the authoring canvas may display partial completions in real time.

As discussed above, the WEP 200 may be designed in various implementations to augment, improve, or streamline various aspects of website development using interactions with the one or more ML models 242. For example, a site controller 204A may access interface 252 on controller device 202A and enter a natural language prompt into ML interface 256 asking the platform to “generate a five page marketing site for a coffee brand with warm colors and bold headings.” Application 202A-1 then sends the prompt to API gateway modules 210A over network 201. Inference connector modules 210C forward the prompt to hosting system 240 which relays it to machine learning models 242. The ML models 242 return structured markup and component definitions that reference images and copy aligned with the request. Build/compilation modules 210B merge the generated markup with schema information pulled from content database 224 through API servers 222 so that every collection reference is valid. Edge delivery modules 210D publish the new artifacts and invalidate only the changed routes which lets user devices 202B immediately load the freshly created pages.

As another example, a site controller 204A may decide to localize the site for Spanish speaking visitors using the same workflow. The site controller 204A issues a prompt in interface 256 that requests translated versions of each collection item stored in content management system 220. API gateway modules 210A receive the prompt along with collection identifiers. Inference connector modules 210C assemble context by fetching the English records and related embeddings from vector database 232A then pass that context to machine learning models 242. The ML models 242 return translated field values which API servers 222 write as new locale variants in content database 224 while platform database 232B records a build dependency for each updated item. Build/compilation modules 210B regenerate only the localized bundles and edge delivery modules 210D tag them with Accept-Language rules so site users automatically receive the correct language version.

In yet another example, during ongoing operation a site user 204B signs in through application 202B-1 and asks an on-page chatbot how to schedule a product launch for next Friday. The question travels through network 201 to API gateway modules 210A and is passed to inference connector modules 210C with user context from user database 232C. Machine learning models 242 analyze the prompt and return a step list that includes creating a draft collection item, assigning a release date, and triggering a publish event. The response also contains signed mutation requests that API servers 222 may execute on behalf of the authenticated user. Orchestration logic writes the new item to content database 224, schedules a timed build in platform database 232B, and notifies build and compilation modules 210B to pre render the page. Edge delivery modules 210D queue a cache purge for the launch path so the new content appears exactly when the scheduled date arrives.

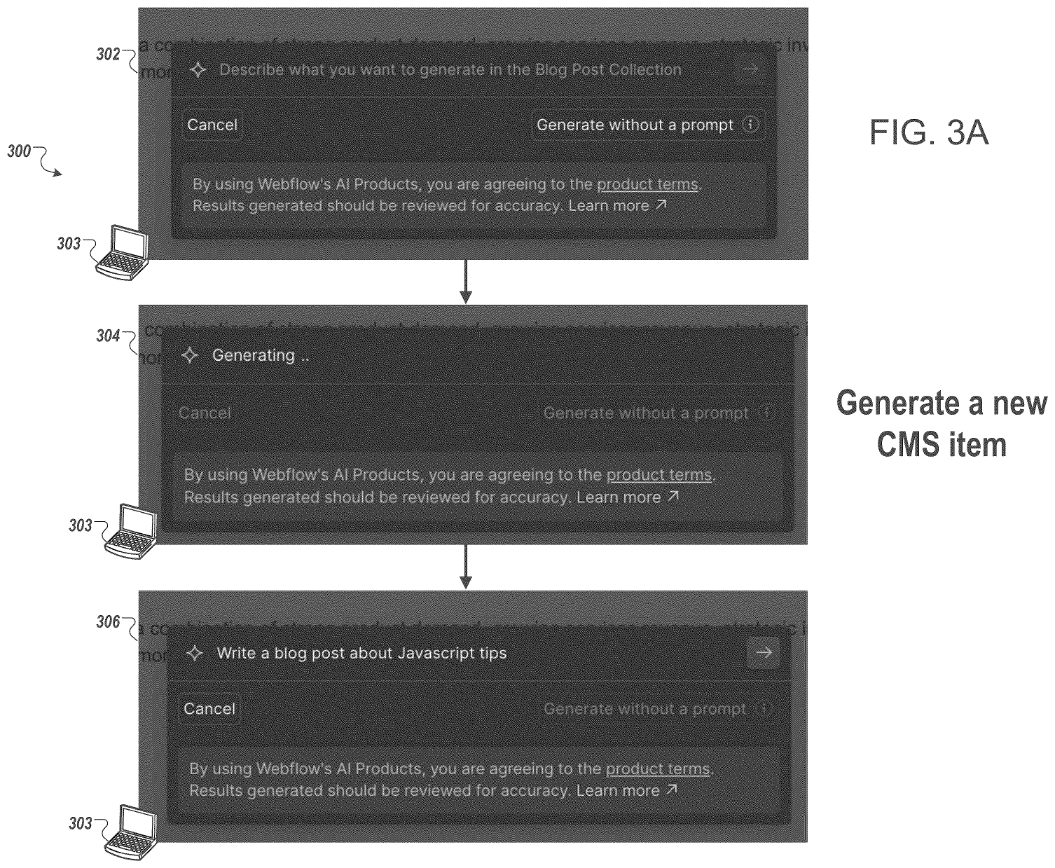

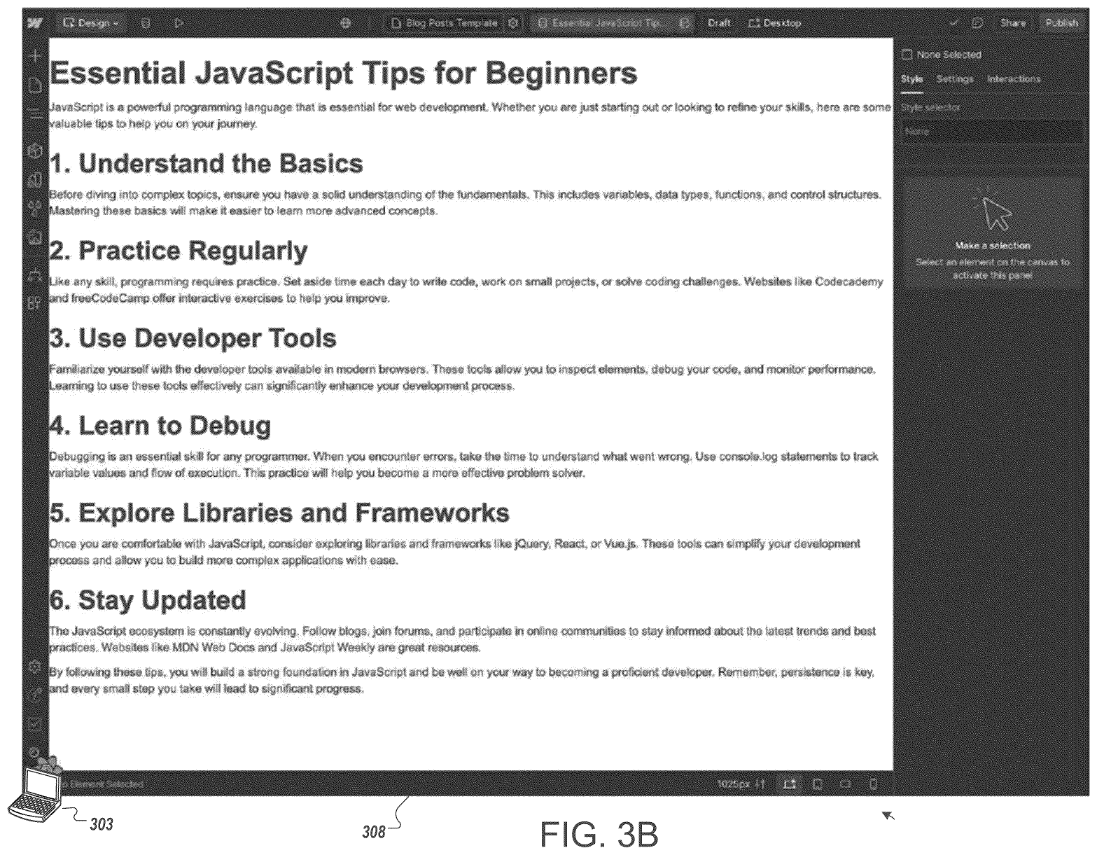

FIG. 3A illustrates example user interfaces 300 for generating website content using machine learning. In particular, the user interfaces 300 illustrates a sequence of interfaces presented to a user on client device 303 to generate a new content item. Interface 302, for example, presents a prompt panel for the Blog Posts collection that asks the user to “describe what you want to generate,” with a free-form text field and optional quick actions to guide the request. Interface 304, for example, shows the in-progress state after submission. The in-progress state includes, for example, a “Generating . . . ” message with a progress indicator and, a cancel GUI control, while the system obtains candidate content. Interface 306, for example, displays a recommendation card proposing a specific blog post, e.g., JavaScript tips, and a control to accept the suggestion as a new item, view alternative outputs, or perform a regeneration.

In some cases, the user interfaces 300 may expose a regenerate icon that enables a user update one or more fields. If the user selects the regenerate icon, this opens a GUI bar with quick actions, such as the previous actions mentioned above. The system may perform functions related to one of the quick actions and apply the result in line.

FIG. 3B illustrates other example user interfaces 300 for generating website content using machine learning. In particular, FIG. 3B illustrates a user interface 308 as a result of accepting the suggestion from user interface 306. For example, user interface 308 illustrates a draft blog post page titled “Essential JavaScript Tips for Beginners.” The page shows populated fields in the Blog Posts collection including, for example, a title, headings, summary, body text, and other data rendered from a validated model output. The user interacting with client device 303 may revise any portion of this text using the same inline actions described for FIG. 1 stages (A)-(L). These actions include, for example, rewriting, changing tone, translating, expanding, shortening, fixing spelling and grammar, or regeneration, before committing the update.

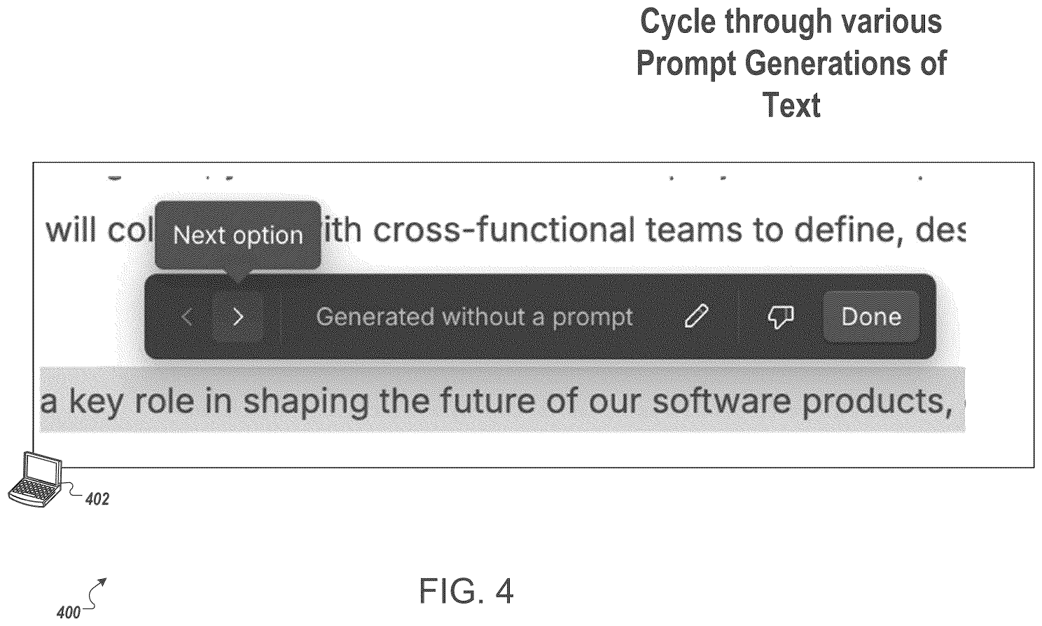

FIG. 4 illustrates an example user interface 400 for cycling through different output alternatives from the machine learning model for generating website content. The interface 400 presents a GUI selector that lets the user step through validated candidate options without leaving the page. The GUI selector includes next and previous arrows.

In some implementations, each of those options or alternatives are returned by the ML model in a single invocation of the ML model. The user interface 400 includes a prompt input so that the user may provide or refine instructions for regenerating or generating candidate outputs. The user interface 400 also includes a thumbs-down control for feedback of a shown candidate output, and a Done control that commits the currently displayed candidate output or dismisses the non-displayed candidate outputs. If the thumbs-down control is selected, a brief feedback dialog is presented for user input. Responses may be logged with anonymized data and hashed in order to improve prompt templates and rules. In some cases, the user interface 400 includes a difference view that overlays insertions and deletions between the original text and the text of the candidate output. This allows the user to visually review the changes and accept the changes if appropriate.

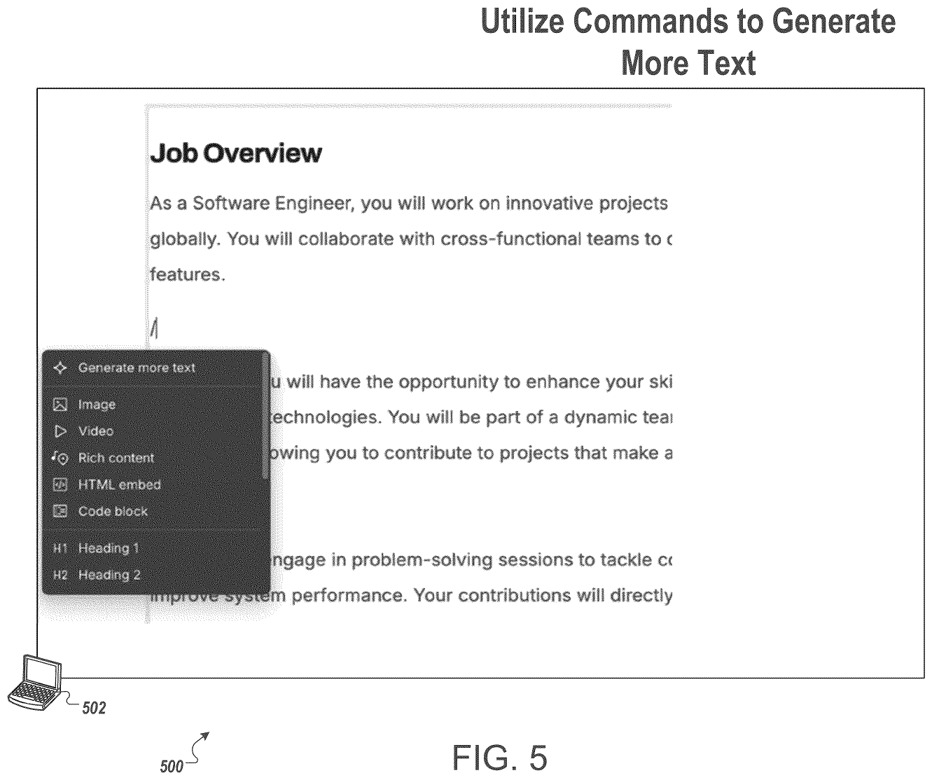

FIG. 5 illustrates an example user interface 500 for performing rich text actions on a webpage for generating website content. In particular, as shown on the user interface 500, when a user types the “/” trigger at the insertion point, the interface displays a set of selectable functions. The set of selectable functions includes, for example, Generate more text, Insert Image, Insert Video, Rich content, HTML embed, Code block, Heading 1, and Heading 2.

Selecting the “Generate more text” initiates the assisted flow described with respect to stages (A) through (L) of FIG. 1. Upon validation, the server may insert the generated text at the “/” position. If the user selects the structural or media options, e.g., Insert Image, Insert Video, Rich content, HTML embed, Code Block, Heading 1, and Heading 2, then the system may insert the corresponding element at the same location indicated by the “/” trigger. The media may be represented by one or more embedded assets, for example. As a result, the system may place the result of the processing between the slash markers, or another type of marker, while preserving surrounding context on the webpage.

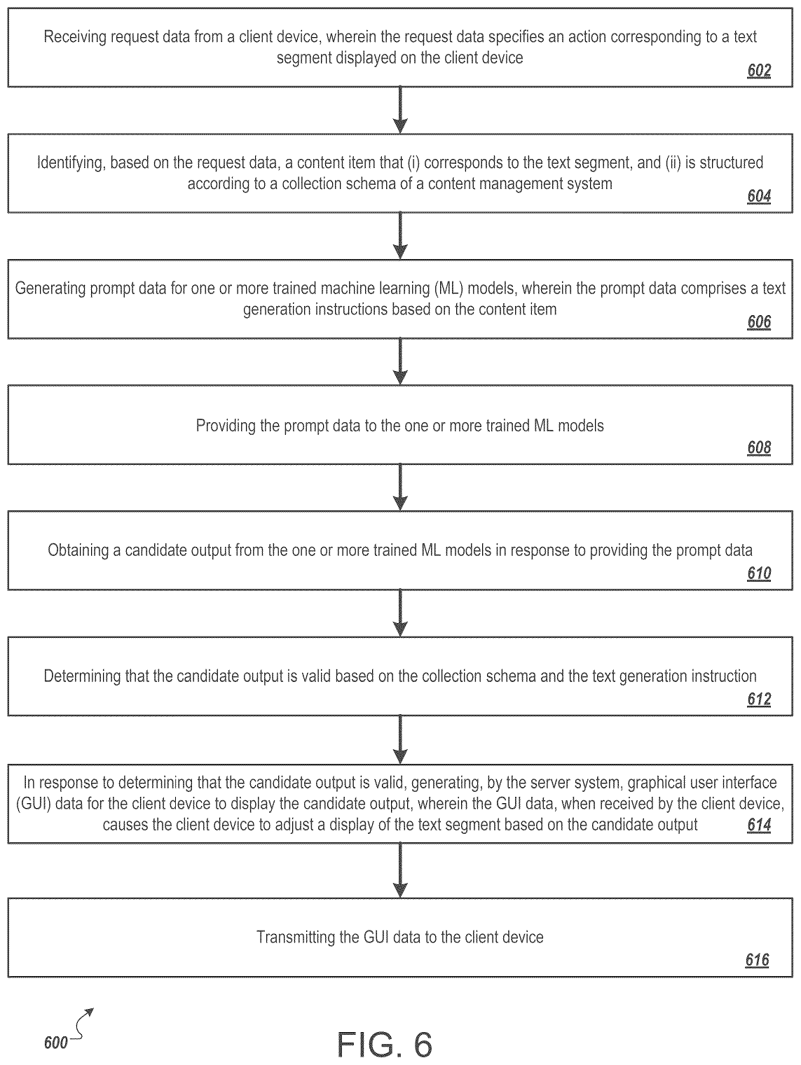

FIG. 6 a flow chart illustrating an example of a method 600 for creating website content according to a user request using machine learning. The server 122 of FIG. 1 may perform the method 600, for example.

During 602, the server may receive request data from a client device. The request data specifies an action corresponding to a text segment displayed on the client device. The server may receive, for example, the request to perform at least one of a rewrite, a change in tone, a translation, a correction of spelling and grammar, or a change in length, of the text segment, and the action is selected by a user interacting with the text segment on the client device.

During 604, the server may identify, based on the request data, a content item that corresponds to the text segment, and is structured according to a collection schema of a content management system. Identifying the content item includes the server extracts an identifier from the request data. The server may locate the content item within the content management system using the identifier. The collection schema specifies a plurality of data types, permitted fields, field data types, and disallowed fields for the content item.

During 606, the server may generate prompt data for one or more trained machine learning (ML) models, the prompt data includes a text generation instruction based on the content item. The text generation instruction includes a machine-readable representation of rules derived from the collection schema. Generating prompt data for one or more trained ML models includes the server extracting the data including the text segment, a second text segment surrounding the text segment, and a collection applied on a webpage including the text segment, generating a machine-readable data encoding the permitted fields, the field data types, formats, and the disallowed fields specified by the collection schema, and embedding the machine-readable data within the prompt data.

During 608, the server may provide the prompt data to the one or more trained ML models. The server may provide the prompt data to the one or more trained ML models over a network.

During 610, the server may obtain a candidate output from the one or more trained ML models in response to providing the prompt data. The candidate output includes a JavaScript Object Notation (JSON) object that includes values for a set of permitted fields specified by the collection schema.

In some implementations, the server may obtain a second candidate output from the one or more trained ML models. The server determine that the second candidate output does not conform to one or more constraints specified in the collection schema. In response to determining that the second candidate output does not conform to the one or more constraints specified in the collection schema, the server generates an error report identifying one or more fields from the second candidate output that does not successfully conform to the one or more constraints specified in the collection schema. The server transmits the error report to the client device.

In some implementations, the server may identify, based on the request data, a second content item that is specified in the content management system as being associated with the content item. The server may generate second prompt data for the one or more trained ML models, where the second prompt data includes a second text generation instruction based on the second content item. The server may provide the second prompt data to the one or more trained ML models. The server may obtain a second candidate output from the one or more trained ML models in response to providing the second prompt data. The GUI data includes the second text segment, metadata identifying a target collection associated with the content item, and a second content item associated with the second text segment.

In some implementations, the server may obtain a plurality of candidate outputs from the one or more trained ML models. The server may generate second GUI data based on the plurality of candidate outputs, where the second GUI data includes a candidate controller configured to enable a user to cycle through each candidate output of the plurality of candidate outputs for display on the client device, and a candidate selector that enables the user to select one of the plurality of candidate outputs to replace the text segment. The server may generate a difference view that includes one or more edits between the text segment and each candidate output included in the plurality of candidate outputs.

During 612, the server may determine that the candidate output is valid based on the collection schema and the text generation instruction. In some implementations, the server may determine that a first subset among the plurality of candidate outputs is valid. The server may determine that a second subset among the plurality of candidate outputs is not valid, where candidate outputs included in the second subset are not included in the first subset. The server may discard candidate outputs included in the second subset, and the GUI data further includes an indicator identifying candidate outputs included in the second subset that have been discarded by the server system.

During 614, in response to determining that the candidate output is valid, the server generate graphical user interface (GUI) data for the client device to display the candidate output, the GUI data, when received by the client device, causes the client device to adjust a display of the text segment based on the candidate output.

During 616, the server may transmit the GUI data to the client device. In some implementations, the GUI data specifies a regenerate control setting. The server may receive user input data indicating activation of the regenerate control setting after the GUI data has been transmitted to the client device. In response to receiving the user input data, the server may generate second prompt data for the one or more trained ML models, where the second prompt data includes a second text generation instruction based on the user input data indicating activation of the regenerate control. The server may provide the second prompt data to the one or more trained ML models. The server may obtain a second candidate output from the one or more trained ML models in response to providing the second prompt data.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification may be realized in digital electronic circuitry, in tangibly-embodied computer software or firmware, in computer hardware, including the structures disclosed in this specification and their structural equivalents, or in combinations of one or more of them. Implementations of the subject matter described in this specification may be implemented as one or more computer programs (e.g., one or more modules of computer program instructions) encoded on a tangible non-transitory storage medium for execution by, or to control the operation of, data processing apparatus. The computer storage medium may be a machine-readable storage device, a machine-readable storage substrate, a random or serial access memory device, or a combination of one or more of them. The program instructions may be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus may also be, or further include special purpose logic circuitry (e.g., an FPGA (field programmable gate array) or an ASIC (application-specific integrated circuit)). The apparatus may optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, may be written in any form of programming language, including compiled or interpreted languages, or declarative or procedural languages; and it may be deployed in any form, including as a stand-alone program or as a module, component, subroutine, or other unit suitable for use in a computing environment. A program may, but need not, correspond to a file in a file system. A program may be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines may be installed and running on the same computer or computers.

The processes and logic flows described in this specification may be performed by one or more programmable computers executing one or more computer programs to perform functions by operating on input data and generating output. The processes and logic flows may also be performed by special purpose logic circuitry (e.g., a FPGA, an ASIC), or by a combination of special purpose logic circuitry and one or more programmed computers.

Computers suitable for the execution of a computer program may be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory may be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media, and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification may be provisioned on a computer having a display device (e.g., a CRT (cathode ray tube) or LCD (liquid crystal display) monitor) for displaying information to the user and a keyboard and a pointing device (e.g., a mouse, a trackball), by which the user may provide input to the computer. Other kinds of devices may be used to provide for interaction with a user as well; for example, feedback provided to the user may be any form of sensory feedback (e.g., visual feedback, auditory feedback, tactile feedback); and input from the user may be received in any form, including acoustic, speech, or tactile input. In addition, a computer may interact with a user by sending documents to and receiving documents from a device that is used by the user; for example, by sending web pages to a web browser on a user's device in response to requests received from the web browser. Also, a computer may interact with a user by sending text messages or other forms of message to a personal device (e.g., a smartphone that is running a messaging application), and receiving responsive messages from the user in return.

Data processing apparatus for implementing machine learning models may also include, for example, special-purpose hardware accelerator units for processing common and compute-intensive parts of machine learning training or production (e.g., inference, workloads).

Machine learning models may be implemented and deployed using a machine learning framework (e.g., a TensorFlow framework, a Microsoft Cognitive Toolkit framework, an Apache Singa framework, an Apache MXNet framework).

Implementations of the subject matter described in this specification may be realized in a computing system that includes a back-end component (e.g., as a data server) a middleware component (e.g., an application server), and/or a front-end component (e.g., a client computer having a GUI, a web browser, or an app through which a user may interact with implementations of the subject matter described in this specification), or any combination of one or more such back-end, middleware, or front-end components. The components of the system may be interconnected by any form or medium of digital data communication (e.g., a communication network). Examples of communication networks include a local area network (LAN) and a wide area network (WAN) (e.g., the Internet).

The computing system may include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) may be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially be claimed as such, one or more features from a claimed combination may in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems may generally be integrated together in a single software product or packaged into multiple software products.

Particular implementations of the subject matter have been described. Other implementations are within the scope of the following claims. For example, the actions recited in the claims may be performed in a different order and still achieve desirable results. As one example, the processes depicted in the accompanying figures do not necessarily require the particular order shown, or sequential order, to achieve desirable results. In some cases, multitasking and parallel processing may be advantageous.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
receiving, by a server system, request data from a client device, wherein the request data specifies an action corresponding to a text segment displayed on the client device;
identifying, by the server system and based on the request data, a content item that (i) corresponds to the text segment, and (ii) is structured according to a collection schema of a content management system;
generating, by the server system, prompt data for one or more trained machine learning (ML) models, wherein the prompt data comprises a text generation instruction based on the content item;
providing, by the server system, the prompt data to the one or more trained ML models;
obtaining, by the server system, a candidate output from the one or more trained ML models in response to providing the prompt data;
determining, by the server system, that the candidate output is valid based on the collection schema and the text generation instruction;
in response to determining that the candidate output is valid, generating, by the server system, graphical user interface (GUI) data for the client device to display the candidate output, wherein the GUI data, when received by the client device, causes the client device to adjust a display of the text segment based on the candidate output; and
transmitting, by the server system, the GUI data to the client device.

2. The computer-implemented method of claim 1, wherein the text generation instruction comprises a machine-readable representation of rules derived from the collection schema.

3. The computer-implemented method of claim 1, wherein receiving the request to perform the action with respect to the text segment displayed on the client device comprises:
receiving, by the server system, the request to perform at least one of a rewrite, a change in tone, a translation, a correction of spelling and grammar, or a change in length, of the text segment,
wherein the action is selected by a user interacting with the text segment on the client device.

4. The computer-implemented method of claim 1, wherein identifying the content item comprises:
extracting, by the server system, an identifier from the request data; and
locating, by the server system, the content item within the content management system using the identifier.

5. The computer-implemented method of claim 1, wherein the collection schema specifies a plurality of data types, permitted fields, field data types, and disallowed fields for the content item.

6. The computer-implemented method of claim 5, wherein generating prompt data for one or more trained ML models comprises:
extracting, by the server system, data from the request, the data comprising (i) the text segment, (ii) a second text segment surrounding the text segment, and (iii) a collection applied on a webpage including the text segment;
generating, by the server system, a machine-readable data encoding the permitted fields, the field data types, formats, and the disallowed fields specified by the collection schema; and
embedding, by the server system, the machine-readable data within the prompt data.

7. The computer-implemented method of claim 1, wherein the prompt data is provided to the one or more trained ML models over a network.

8. The computer-implemented method of claim 1, wherein the candidate output comprises a JavaScript Object Notation (JSON) object that includes values for a set of permitted fields specified by the collection schema.

9. The computer-implemented method of claim 1, further comprising:
obtaining, by the server system, a second candidate output from the one or more trained ML models;
determining, by the server system, that the second candidate output does not conform to one or more constraints specified in the collection schema;
in response to determining that the second candidate output does not conform to the one or more constraints specified in the collection schema, generating, by the server system, an error report identifying one or more fields from the second candidate output that does not successfully conform to the one or more constraints specified in the collection schema; and
transmitting, by the server system, the error report to the client device.

10. The computer-implemented method of claim 1, further comprising:
identifying, by the server system and based on the request data, a second content item that is specified in the content management system as being associated with the content item;
generating, by the server system, second prompt data for the one or more trained ML models, wherein the second prompt data comprises a second text generation instruction based on the second content item;
providing, by the server system, the second prompt data to the one or more trained ML models; and
obtaining, by the server system, a second candidate output from the one or more trained ML models in response to providing the second prompt data.

11. The computer-implemented method of claim 10, wherein the GUI data comprises (i) the second text segment, (ii) metadata identifying a target collection associated with the content item, and (iii) a second content item associated with the second text segment.

12. The computer-implemented method of claim 1, further comprising:
obtaining, by the server system, a plurality of candidate outputs from the one or more trained ML models; and
generating, by the server system, second GUI data based on the plurality of candidate outputs, wherein the second GUI data comprises (i) a candidate controller configured to enable a user to cycle through each candidate output of the plurality of candidate outputs for display on the client device, and (ii) a candidate selector that enables the user to select one of the plurality of candidate outputs to replace the text segment.

13. The computer-implemented method of claim 12, wherein generating the second GUI data comprises generating, by the server system, a difference view that comprises one or more edits between the text segment and each candidate output included in the plurality of candidate outputs.

14. The computer-implemented method of claim 12, further comprising:
determining, by the server system, that a first subset among the plurality of candidate outputs is valid;
determining, by the server system, that a second subset among the plurality of candidate outputs is not valid, wherein candidate outputs included in the second subset are not included in the first subset; and
discarding, by the server system, candidate outputs included in the second subset,
wherein the GUI data further comprises an indicator identifying candidate outputs included in the second subset that have been discarded by the server system.

15. The computer-implemented method of claim 1, wherein:
the GUI data specifies a regenerate control setting; and
the method further comprises:
receiving, by the server system, user input data indicating activation of the regenerate control setting after the GUI data has been transmitted to the client device, and
in response receiving the user input data:
generating, by the server system, second prompt data for the one or more trained ML models, wherein the second prompt data comprises a second text generation instruction based on the user input data indicating activation of the regenerate control;
providing, by the server system, the second prompt data to the one or more trained ML models; and
obtaining, by the server system, a second candidate output from the one or more trained ML models in response to providing the second prompt data.

16. A system comprising:
one or more computers; and
one or more storage devices storing instructions that are operable, when executed by the one or more computers, to cause the one or more computers to perform operations comprising:
receiving, by a server system, request data from a client device, wherein the request data specifies an action corresponding to a text segment displayed on the client device;
identifying, by the server system and based on the request data, a content item that (i) corresponds to the text segment, and (ii) is structured according to a collection schema of a content management system;
generating, by the server system, prompt data for one or more trained machine learning (ML) models, wherein the prompt data comprises a text generation instruction based on the content item;
providing, by the server system, the prompt data to the one or more trained ML models;
obtaining, by the server system, a candidate output from the one or more trained ML models in response to providing the prompt data;
determining, by the server system, that the candidate output is valid based on the collection schema and the text generation instruction;
in response to determining that the candidate output is valid, generating, by the server system, graphical user interface (GUI) data for the client device to display the candidate output, wherein the GUI data, when received by the client device, causes the client device to adjust a display of the text segment based on the candidate output; and
transmitting, by the server system, the GUI data to the client device.

17. The system of claim 16, wherein the text generation instruction comprises a machine-readable representation of rules derived from the collection schema.

18. The system of claim 16, wherein receiving the request to perform the action with respect to the text segment displayed on the client device comprises:
receiving, by the server system, the request to perform at least one of a rewrite, a change in tone, a translation, a correction of spelling and grammar, or a change in length, of the text segment,
wherein the action is selected by a user interacting with the text segment on the client device.

19. The system of claim 16, wherein identifying the content item comprises:
extracting, by the server system, an identifier from the request data; and
locating, by the server system, the content item within the content management system using the identifier.

20. One or more non-transitory computer-readable media storing software comprising instructions executable by one or more computers which, upon such execution, cause the one or more computers to perform operations comprising:
receiving, by a server system, request data from a client device, wherein the request data specifies an action corresponding to a text segment displayed on the client device;
identifying, by the server system and based on the request data, a content item that (i) corresponds to the text segment, and (ii) is structured according to a collection schema of a content management system;
generating, by the server system, prompt data for one or more trained machine learning (ML) models, wherein the prompt data comprises a text generation instruction based on the content item;
providing, by the server system, the prompt data to the one or more trained ML models;
obtaining, by the server system, a candidate output from the one or more trained ML models in response to providing the prompt data;
determining, by the server system, that the candidate output is valid based on the collection schema and the text generation instruction;
in response to determining that the candidate output is valid, generating, by the server system, graphical user interface (GUI) data for the client device to display the candidate output, wherein the GUI data, when received by the client device, causes the client device to adjust a display of the text segment based on the candidate output; and
transmitting, by the server system, the GUI data to the client device.
